(19) United States
(12) Patent Application Publication
(10) Pub. No.: US 2014/0379324 A1
(43) Pub. Date: Dec. 25, 2014

(54) PROVIDING WEB-BASED ALTERNATE TEXT OPTIONS

(71) Applicant: Microsoft Corporation, Redmond, WA (US)

(72) Inventors: IOANNIS KLAPAFTIS, London (GB); ANTONINO GULLÍ, Pisa (IT)

(21) Appl. No.: 13/922,852

(22) Filed: Jun. 20, 2013

(51) Int. Cl. G06F 17/27

(52) U.S. Cl. CPC G06F 17/27
USPC 704/9

(57) ABSTRACT

Systems, methods, and computer-readable storage media are provided for mining web content for synonyms for selected words and/or phrases and presenting such web-based synonyms in the context of applications that permit text editing. As the synonyms are mined from web content, they have potentially more expansive and accurate coverage than a fixed, and often dated, thesaurus. Web content for synonyms of selected words and/or phrases may be mined taking into account at least a portion of the surrounding context in which the selected words and/or phrases appear. Further, web content for synonyms of selected words and/or phrases may be mined taking into account user behaviors that might provide clues as to the intended meaning of the selected words and/or phrases.

### BACKGROUND

The current state-of-the-art in word processing applications, e-mail clients, and the like uses a standard and fixed thesaurus to provide users a list of synonyms for selected words or multi-word expressions or phrases. Such functionality is important as it allows both native and non-native speakers to build and improve their vocabularies, enables both native and non-native speakers to communicate their messages more precisely and effectively, and allows users to produce rich-vocabulary documents that are more likely to keep readers interested and focused than documents with frequent word repetitions. However, the use of a fixed thesaurus as a source of finding synonyms and near-synonyms hinders the aforementioned benefits as the provided alternatives to selected words and/or phrases are often irrelevant and/or do not exist.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for mining web content for synonyms and near-synonyms of selected words and/or phrases and presenting such web-based synonyms and near-synonyms in the context of applications that permit text editing. As the synonyms and near-synonyms are mined from web content, they have potentially more expansive and accurate coverage than a fixed, and often dated, thesaurus. In embodiments, web content for synonyms and near-synonyms of selected words and/or phrases is mined taking into account at least a portion of the surrounding context in which the selected words and/or phrases appear. Further, in embodiments, web content for synonyms and near-synonyms of selected words and/or phrases is mined taking into account user behaviors that might provide clues as to the intended meaning of the selected words and/or phrases. Such embodiments provide a level of disambiguation which allows the filtering of irrelevant or confusing suggestions.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for providing alternate text options in the context of text editing applications, in accordance with an embodiment of the present invention; and

FIG. 4 is a flow diagram showing another exemplary method for providing alternate text options in the context of text editing applications, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for mining web content for synonyms and near-synonyms of selected words and/or phrases and presenting such web-based synonyms and near-synonyms in the context of applications that permit text editing. The current state-of-the-art in word processing application, e-mail clients, and other applications permitting text editing uses a standard and fixed thesaurus to provide users a list of synonyms for selected words or multi-word expressions or phrases. As previously mentioned, such functionality is important as it allows both native and non-native speakers to build and improve their vocabularies, enables both native and non-native speakers to communicate their messages more precisely and effectively, and allows users to produce rich-vocabulary documents that are more likely to keep readers interested and focused than documents with frequent word repetitions. However, the use of a fixed thesaurus as a source of finding synonyms and near-synonyms hinders the aforementioned benefits due to some important limitations.

First, the synonyms or near-synonyms (or related words/phrases) are provided independently of the context surrounding a selected word or phrase. As a result, suggestions are in many cases irrelevant or even confusing, for instance, when there is a pragmatic/semantic relationship between the suggested word/phrase and the selected word or phrase. For instance, suppose a user inputs text stating: “Table 1 shows the results of our analysis.” Suppose further that the user then selects the word “Table” indicating a desire to view alternate word suggestions. A fixed thesaurus will typically provide alternate word choices such as: bench, board, counter, stand, slab, desk, stall, and chart. In context of the sentence in which the word “Table” is presented, the majority of these alternate word choices is irrelevant and, if selected by the user as an alternate word choice, would render the text confusing and/or inaccurate.

Additionally, fixed dictionaries and thesauri miss many meanings of existing words or phrases or even words that have recently been introduced into the language of the text. For instance, suppose a user inputs text regarding the “new MICROSOFT SURFACE,” a tablet device recently introduced into the marketplace by Microsoft Corporation of Redmond, Wash. In an instance such as this, if the user further selects the entire phrase “MICROSOFT SURFACE” in search of alternate words or phrases there for, it is likely that no alternate suggestions will be presented, even though alternatives such as “MICROSOFT tablet,” or “SURFACE tablet” would be appropriate. This limitation is particularly relevant in areas of technology that often change more quickly than the programs providing fixed alternate text suggestions.

In accordance with embodiments of the present invention, as the synonyms and near-synonyms (or related words/phrases) are mined from web content, they have potentially more expansive and accurate coverage than a fixed, and often dated, thesaurus as, for instance, they are not hindered by the timing of entry of a particular word or phrase into the language of the text. In accordance with embodiments of the present invention, web content for synonyms and near-synonyms of selected words and/or phrases may be mined taking into account at least a portion of the surrounding context in which the selected words and/or phrases appear. Further, in accordance with embodiments of the present invention, web content for synonyms and near-synonyms of selected words and/or phrases may be mined taking into account user behaviors that might provide clues as to the intended meaning of the selected words and/or phrases. Such embodiments provide a level of disambiguation which allows the filtering of irrelevant or confusing suggestions.

Accordingly, one embodiment of the present invention is directed to one or more computer-readable storage media storing computer-useable instructions that, when used by one or more computing devices, cause the one or more computing devices to perform a method for providing alternate text options. The method includes receiving at least one word or phrase for which an alternate word or phrase is desired, mining web content to determine at least one alternate word or phrase for the at least one word or phrase, and presenting the at least one alternate word or phrase. If desired, the method may further include identifying prior behavior of the user and utilizing at least a portion of the identified prior behavior of the user to determine the at least one alternate word or phrase.

In another embodiment, the present invention is directed to a method being performed by one or more computing devices including at least one processor, the method for providing alternate text options. The method includes receiving text for which alternate text is desired, receiving at least one contextual signal related to the received text, mining web content to determine a plurality of alternate text options for the received text, filtering the plurality of alternate text options based on the at least one contextual signal to create at least one filtered alternate text option for the received text, and presenting the at least one filtered alternate text option. If desired, the method may further include identifying prior behavior of a user associated with the received text and utilizing at least a portion of the identified prior user behavior to determine the plurality of alternate text options.

In yet another embodiment, the present invention is directed to a system including a text alternative determining engine having one or more processors and one or more computer-readable storage media, and a data store coupled with the text alternative determining engine. The text alternative determining engine is configured to receive text for which alternate text is desired, receive at least one contextual signal related to the received text, mine web content to determine a plurality of alternate text options for the received text, and filter the plurality of alternate text options based on the at least one contextual signal to create at least one filtered alternate text option for the received text. The at least one filtered alternate text option maintains the meaning of the received text. The text alternative determining engine further is configured to present the at least one filtered alternate text option. If desired, the text alternative determining engine may further be configured to identify prior behavior of a user associated with the received text and utilize at least a portion of the identified prior user behavior to determine the plurality of alternate text options.

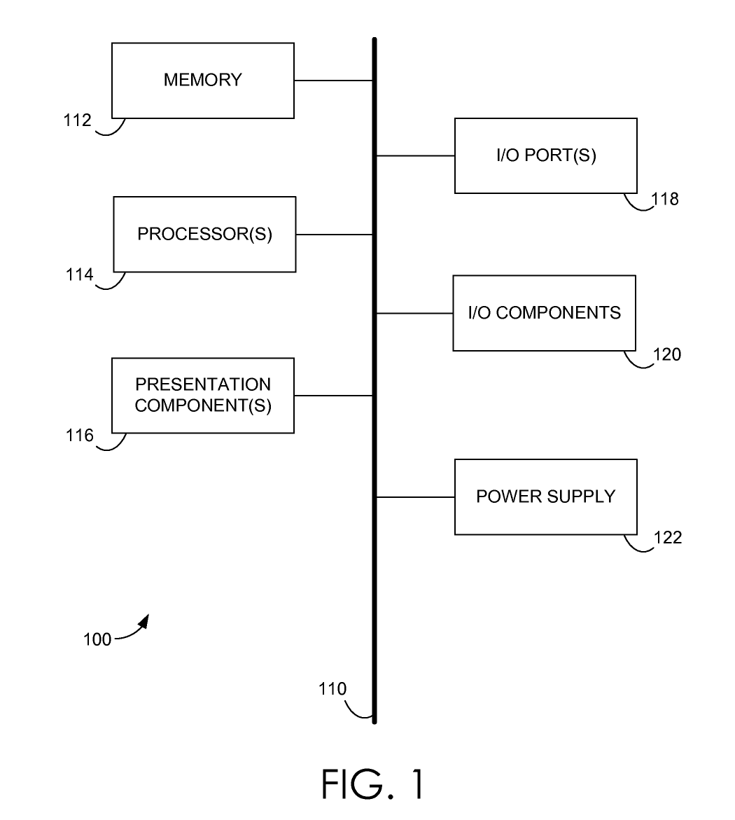

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including, but not limited to, hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as text, requests for alternative text, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

Furthermore, although the term “text alternative determining engine” is used herein, it will be recognized that this term may also encompass servers, web browsers, sets of one or more processes distributed on one or more computers, one or more stand-alone storage devices, sets of one or more other computing or storage devices, any combination of one or more of the above, and the like.

As previously set forth, embodiments of the present invention provide systems, methods, and computer-readable storage media for mining web content for synonyms and near-synonyms of selected words and/or phrases and presenting such web-based synonyms and near-synonyms in the context of applications that permit text editing. As the synonyms and near-synonyms are mined from web content, they have potentially more expansive and accurate coverage than a fixed, and often dated, thesaurus. In embodiments, web content for synonyms and near-synonyms of selected words and/or phrases is mined taking into account at least a portion of the surrounding context in which the selected words and/or phrases appear. Further, in embodiments, web content for synonyms and near-synonyms of selected words and/or phrases is mined taking into account user behaviors that might provide clues as to the intended meaning of the selected words and/or phrases. Such embodiments provide a level of disambiguation which allows the filtering of irrelevant or confusing suggestions.

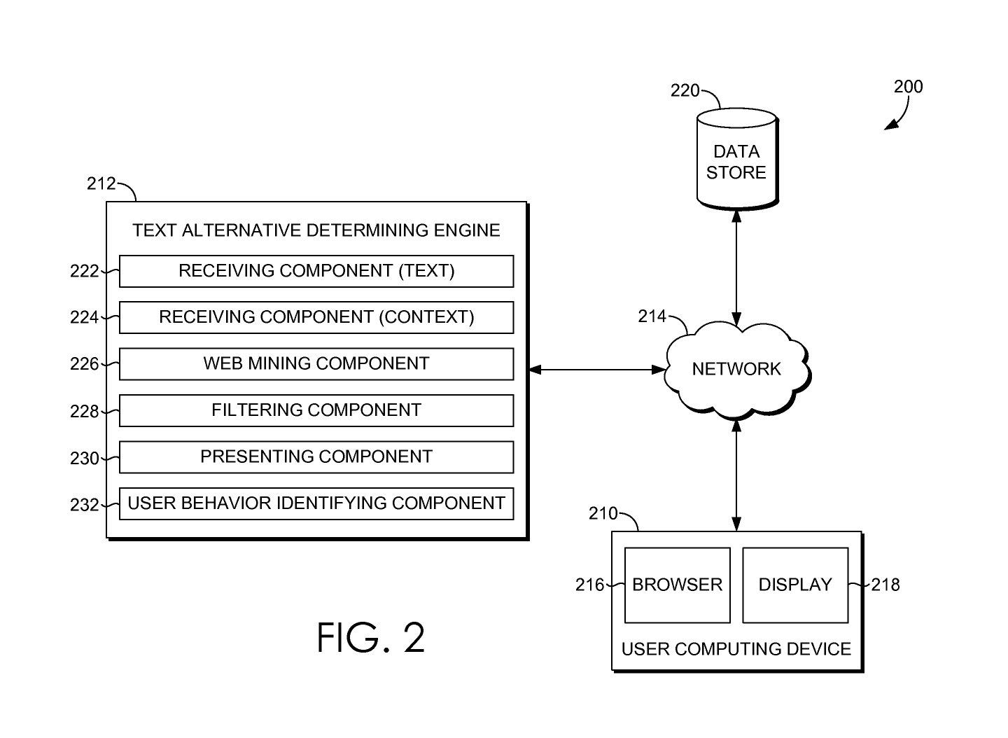

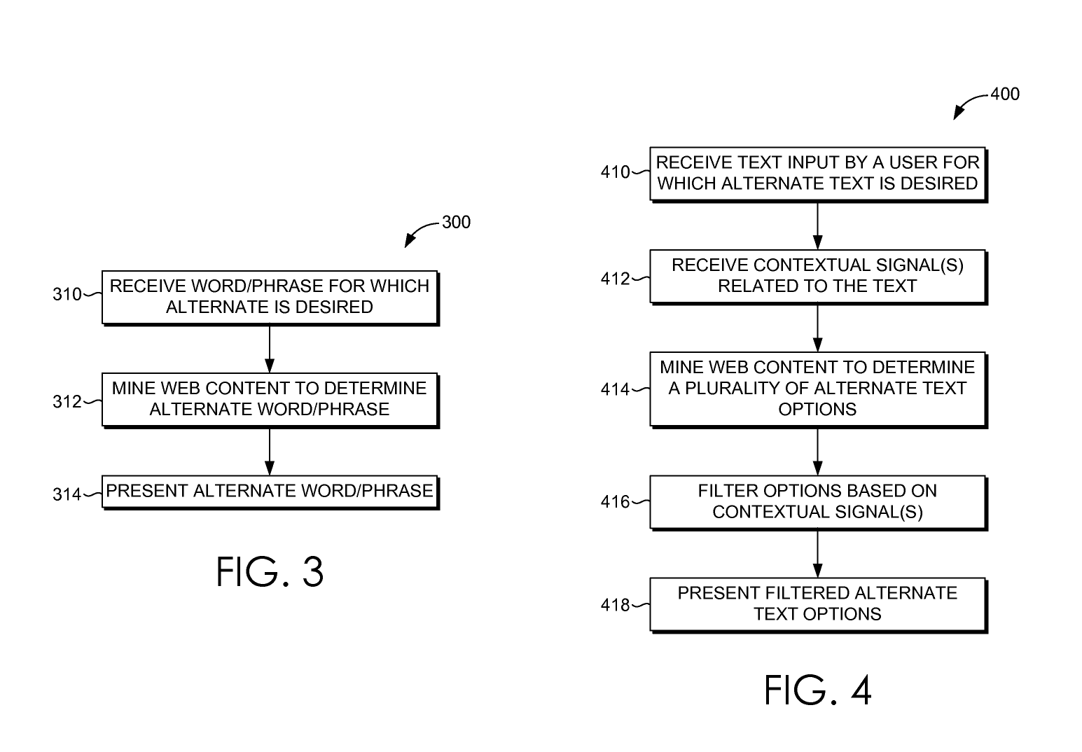

With reference to FIG. 2, a block diagram is provided illustrating an exemplary computing system 200 in which embodiments of the present invention may be employed. Generally, the computing system 200 illustrates an environment in which alternate text suggestions that have been mined from web content (in some instance taking into account context and/or user behavior) may be presented, in accordance with the methods, for instance, illustrated in FIGS. 3 and 4 (more fully described below). Among other components not shown, the computing system 200 generally includes a text alternative determining engine 212 and a user computing device 210 in communication with one another via a network 214. The network 214 may include, without limitation, one or more local area networks (LANs) and/or wide area networks (WANs). Such networking environments are commonplace in offices, enterprise-wide computer networks, intranets and the Internet. Accordingly, the network 214 is not further described herein.

It should be understood that any number of user computing devices 210 and/or text alternative determining engines 212 may be employed in the computing system 200 within the scope of embodiments of the present invention. Each may comprise a single device/interface or multiple devices/interfaces cooperating in a distributed environment. For instance, the text alternative determining engine 212 may comprise multiple devices and/or modules arranged in a distributed environment that collectively provide the functionality of the text alternative determining engine 212 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 210, the text alternative determining engine 212, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of text alternative determining engines 212 and/or user computing devices 210. By way of example only, the text alternative determining engine 212 might be provided as a single computing device, a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown and/or described, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 includes a browser 216 and a display 218. The browser 216, among other things, is configured, in embodiments, to present alternate text suggestions in association with the display 218 of the user computing device 210. The browser 216 is further configured to receive user input of requests for various web pages (including online applications that permit text editing), receive user input text (generally input via a user interface presented on the display 218 and permitting alpha-numeric and/or textual input into a designated input region) and to receive content for presentation on the display 218, for instance, from the text alternative determining engine 212. It should be noted that the functionality described herein as being performed by the browser 216 may be performed by any other application, application software, user interface, or the like capable of rendering web content. It further should be noted that embodiments of the present invention are equally applicable to mobile computing devices and devices accepting touch and/or voice input. Any and all such variations, and any combination thereof, are contemplated to be within the scope of embodiments of the present invention.

The display 218, among other things, is configured to receive user input text (generally input via a user interface presented on the display 218 and permitting alpha-numeric and/or textual input into a designated input region, for instance, in association with an online application that permits text editing) and to receive content for presentation, for instance, from the text alternative determining engine 212. The display 218 is further configured to present received content, e.g., alternate text suggestions. It should be noted that embodiments of the present invention are equally applicable to desktop devices; laptop devices, tablets and other mobile computing devices; and devices accepting touch, gesture and/or voice input. Any and all such variations, and any combination thereof, are contemplated to be within the scope of embodiments of the present invention.

The text alternative determining engine 212 of the computing system 200 of FIG. 2 is configured to, among other things, receive text and text selections for which alternatives are desired, and to determine alternative text suggestions in response thereto. As illustrated, the text alternative determining engine 212 has access to a data store 220. The data store 220 is configured to store information related to one or more alternative text suggestions, user behavior signals, contextual signals, and the like. In embodiments, the data store 220 is configured to be searchable for one or more of the items stored in association therewith. It will be understood and appreciated by those of ordinary skill in the art that the information stored in association with the data store may be configurable and may include any information relevant to text alternatives, behavior signals, contextual signals, and the like. The content and volume of such information are not intended to limit the scope of embodiments of the present invention in any way. Further, the data store 220 may be a single, independent component or a plurality of storage devices, for instance a database cluster, portions of which may reside in association with the text alternative determining engine 212, the user computing device 210, another external computing device (not shown), and/or any combination thereof.

As illustrated, the text alternative determining engine 212 includes a text receiving component 222, a context receiving component 224, a web mining component 226, a filtering component 228, a presenting component 230 and a user behavior identifying component 232. The text receiving component 222 is configured to receive text (including words, phrases and/or expressions) input by a user into an application permitting text editing. Such applications may be offline applications running on a client device (e.g., MICROSOFT OFFICE SUITE, MICROSOFT OUTLOOK SUITE, MICROSOFT SHAREPOINT, each provided by Microsoft Corporation of Redmond, Wash.) or online applications (e.g., OUTLOOK.COM available from Microsoft Corporation of Redmond, Wash.). Generally, input text is received via a user interface presented on the display 218 of the user computing device 210 that permits alpha-numeric and/or textual input into a designated input region. However, embodiments of the present invention are equally applicable to devices accepting touch and/or voice input. Any and all such variations, and any combination thereof, are contemplated to be within the scope of embodiments of the present invention. In accordance with embodiments hereof, alternate text (words, phrases and/or expressions) is desired for at least a portion of the input text.

The context receiving component 224 is configured to receive one or more contextual signals related to received text for which alternate text is desired. Such contextual signals may include, without limitation, other words, phrases and/or expressions surrounding the text for which alternate text is desired, other documents open on the client device, recent searches conducted by the user, and the like. Generally, contextual signals may include any information which may provide clues as to an intent of the user and, accordingly, a context for the meaning of the text for which alternate text is desired.

The web mining component 226 is configured to mine web content to determine alternate text options for the text for which alternate text is desired. Any content available on the web may be mined to determine one or more alternate text options. In embodiments, Machine Learning and Natural Language Processing techniques (e.g., lexical substitution techniques) are utilized in making such determination. Web mining techniques are known to those of ordinary skill in the art and, accordingly, are not further discussed herein. Contextual signals and/or user behavior (as more fully described below), may be utilized to focus the web content mining.

The filtering component 228 is configured to filter alternate text options determined through web mining in an attempt to insure greater relevance. Such filtering may be based upon contextual signals and/or user behavior (as more fully described below) to create a filtered list of alternate text options.

The presenting component 230 is configured to present any alternate text options (and/or filtered alternate text options, where applicable) to the user. In embodiments, such presentation may be by virtue of a list displayed in proximity to the text for which alternate text options are desired.

The user behavior identifying component 232 is configured to identity one or more user behavior signals that may provide information regarding the user's intent and, accordingly, the meaning of the text for which alternates are desired. Behavior signals may include, without limitation, preferences and/or selections made by the user in prior text editing sessions within the same text editing application or preferences and/or selections made by the user in other text editing applications such that the system 200 learns from user selections what types of alternatives the user desires. Any and all such variations, and any combination thereof, are contemplated to be within the scope of embodiments of the present invention.

Turning now to FIG. 3, a flow diagram is illustrated showing an exemplary method 300 for providing alternate text options in the context of applications that permit text editing, in accordance with an embodiment of the present invention. As indicated at block 310, at least one word or phrase for which alternate words and/or phrases are desired is received, for instance, utilizing the text receiving component 222 of the text alternative determining engine 212 of FIG. 2. As indicated at block 312, web content is mined to determine at least one alternate word or phrase for the received word or phrase for which alternative words and/or phrases are desired (e.g., utilizing the web mining component 226 of the text alternative determining engine 212 of FIG. 2). At least one alternate word or phrase for the received word or phrase for which alternatives are desired is presented (for instance, utilizing the presenting component 230 of the text alternative determining engine 212 of FIG. 2). This is indicated at block 314.

With reference now to FIG. 4, a flow diagram is illustrated showing an exemplary method 400 for providing alternate text options in the context of applications that permit text editing, in accordance with an embodiment of the present invention. As indicated at block 410, text input by a user for which alternate text is desired is received (for instance, utilizing text receiving component 222 of the text alternative determining engine 212 of FIG. 2). As indicated at block 412, at least one contextual signal related to the received text is received (e.g., utilizing the context receiving component 224 of the text alternative determining engine 212 of FIG. 2). Web content is mined to determine a plurality of alternate text options for the received text input by the user, for instance, utilizing the web mining component 226 of the text alternative determining engine 212 of FIG. 2), as indicated at block 414. As indicated at block 416, the plurality of alternate text options is filtered (e.g., utilizing the filtering component 228 of the text alternative determining engine 212 of FIG. 2) based on the at least one contextual signal. Created is at least one filtered alternate text option for the text input by the user. As indicated at block 418, the at least one filtered alternate text option is presented to the user, for instance, utilizing the presenting component 230 of the text alternative determining engine 212 of FIG. 2.

As can be understood, embodiments of the present invention provide systems, methods, and computer-readable storage media for, among other things, mining web content for synonyms and near-synonyms of selected words and/or phrases and presenting such web-based synonyms and near-synonyms in the context of applications that permit text editing. As the synonyms and near-synonyms are mined from web content, they have potentially more expansive and accurate coverage than a fixed, and often dated, thesaurus. In embodiments, web content for synonyms and near-synonyms of selected words and/or phrases is mined taking into account at least a portion of the surrounding context in which the selected words and/or phrases appear. Further, in embodiments, web content for synonyms and near-synonyms of selected words and/or phrases is mined taking into account user behaviors that might provide clues as to the intended meaning of the selected words and/or phrases. Such embodiments provide a level of disambiguation which allows the filtering of irrelevant or confusing suggestions.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIGS. 3 and 400 of FIG. 4 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for providing alternate text options, the method comprising:
receiving at least one word or phrase for which an alternate word or phrase is desired;
mining web content to determine at least one alternate word or phrase for the at least one word or phrase; and
presenting the at least one alternate word or phrase.

2. The one or more computer-readable storage media of claim 1, wherein the method further comprises utilizing context associated with the at least one word or phrase to determine the at least one alternate word or phrase.

3. The one or more computer-readable storage media of claim 1, wherein at least one of a Machine Learning technique and a Natural Language Processing technique is utilized to determine the at least one alternate word or phrase.

4. The one or more computer-readable storage media of claim 1, wherein receiving the at least one word or phrase for which the alternate word or phrase is desired comprises receiving the at least one word or phrase from an offline process running on a client device.

5. The one or more computer-readable storage media of claim 1, wherein the at least one alternate word or phrase maintains a meaning of the at least one word or phrase.

6. The one or more computer-readable storage media of claim 1, wherein receiving the at least one word or phrase for which the alternate word or phrase is desired comprises receiving the at least one word or phrase from a user, and wherein the method further comprises:
identifying prior behavior of the user; and
utilizing at least a portion of the identified prior behavior of the user to determine the at least one alternate word or phrase.

7. The one or more computer-readable storage media of claim 1, wherein the at least one alternate word or phrase is a synonym for the at least one word or phrase.

8. The one or more computer-readable storage media of claim 1, wherein the at least one alternate word or phrase is a re-phrasing of the at least one word or phrase.

9. A method being performed by one or more computing devices including at least one processor, the method for providing alternate text options, the method comprising:
receiving text for which alternate text is desired;
receiving at least one contextual signal related to the received text;
mining web content to determine a plurality of alternate text options for the received text;
filtering the plurality of alternate text options based on the at least one contextual signal to create at least one filtered alternate text option for the text input by the user; and
presenting the at least one filtered alternate text option.

10. The method of claim 9, wherein at least one of a Machine Learning technique and a Natural Language Processing technique is utilized to determine the plurality of alternate text options for the received text.

11. The method of claim 9, wherein receiving text for which alternate text is desired comprises receiving the text from an offline process running on a client device.

12. The method of claim 9, wherein the at least one filtered alternate text option maintains a meaning of the received text.

13. The method of claim 9, wherein the method further comprises:
identifying prior behavior of a user associated with the received text; and
utilizing at least a portion of the identified prior user behavior to determine the plurality of alternate text options.

14. The method of claim 9, wherein the method further comprises:
identifying prior behavior of a user associated with the received text; and
utilizing at least a portion of the identified prior user behavior to filter the plurality of alternate text options and create the at least one filtered alternate text option for the received text.

15. The method of claim 9, wherein the at least one filtered alternate text option is a synonym for the received text.

16. The method of claim 9, wherein the at least one filtered alternate text option is a re-phrasing of the received text.

17. A system comprising:
a text alternative determining engine having one or more processors and one or more computer-readable storage media; and
a data store coupled with the text alternative determining engine,
wherein the text alternative determining engine:
receives text for which alternate text is desired;
receives at least one contextual signal related to the received text;
mines web content to determine a plurality of alternate text options for the received text;
filters the plurality of alternate text options based on the at least one contextual signal to create at least one filtered alternate text option for the received text, the at least one filtered alternate text option maintaining a meaning of the received text; and
presents the at least one filtered alternate text option.

18. The system of claim 17, wherein the text alternative determining engine receives the text from an offline process running on a client device.

19. The system of claim 17, wherein the text alternative determining engine further:
identifies prior behavior of a user associated with the received text; and
utilizes at least a portion of the identified prior user behavior to determine the plurality of alternate text options.

20. The system of claim 17, wherein the at least one filtered alternate text option is one of a synonym for the received text and a re-phrasing of the received text.
